(19) United States
(12) Patent Application Publication
(10) Pub. No.: US 2018/0018422 A1
(43) Pub. Date: Jan. 18, 2018

(54) SYSTEMS AND METHODS FOR NUCLEIC ACID-BASED IDENTIFICATION

(71) Applicant: Life Technologies Corporation, Carlsbad, CA (US)

(72) Inventors: Robert LAGACE, Oakland, CA (US); Chien-Wei Chang, Belmont, CA (US); Lori Hennessy, San Mateo, CA (US)

(21) Appl. No.: 15/667,236

(22) Filed: Aug. 2, 2017

Related U.S. Application Data
(62) Division of application No. 14/238,455, filed on May 9, 2014, now abandoned.
(60) Provisional application No. 61/522,669, filed on Aug. 11, 2011.

(51) Int. Cl. G06F 19/14; G06F 19/18

(52) U.S. Cl. CPC G06F 19/14; G06F 19/18

(57) ABSTRACT

Systems and methods for calculating a predictive index of identity of a nucleic acid sample using polymorphic genetic marker data are provided. In one embodiment, a predictive index of identity of the nucleic acid sample is calculated using a value from a second set of data from a polymorphic genetic marker that is not linked to a polymorphic genetic marker used to produce a first set of data. In another embodiment, the predictive index of identity is calculated using a value from a second set of data from a polymorphic genetic marker that is linked to a polymorphic genetic marker used to produce the first set of data. Systems and methods for generating an identifier for a biological sample and for verifying a relationship between a biological sample and an identifier are also provided. The identifier is an encoding of a set of values for polymorphic genetic markers.

### RELATED APPLICATIONS

This application is a divisional of U.S. application Ser. No. 14/238,455 filed May 9, 2014 which is a U.S. National Application filed under 35 U.S.C. §371 of International Application No. PCT/US2012/050640 filed Aug. 13, 2012 which claims priority to U.S. Provisional Application No. 61/522,669 filed Aug. 11, 2011, the disclosures of which are hereby incorporated by reference in their entirety.

### INTRODUCTION

Identification based on nucleic acid analysis typically includes the steps of sample preparation, nucleic acid quantification, PCR (polymerase chain reaction) amplification, genetic analysis, and data interpretation. A nucleic acid can include, but is not limited to, deoxyribonucleic acid (DNA), ribonucleic acid (RNA), or complementary deoxyribonucleic acid (cDNA). Identification can include, for example, but not limited to, human identification, paternity testing and cell line identification. Variations in genome sequences have been identified among populations and individuals and qualified for human identification. Various PCR kits have been developed for analyzing genomic and transcribed variations in nucleic acids. Nucleic acid variations of interest are amplified using, for example, but not limited to, a PCR kit. Genetic analysis is performed on these variations to characterize the specific genetic makeup of the sample. This genetic analysis is typically performed using an instrument capable of size separation of PCR amplicons (in a mobility dependent fashion) or sequencing the nucleic acid being analyzed. Data from the instrument is then interpreted using a computer or other type of processing device.

Currently, short tandem repeats (STRs) of a nucleic acid are used as markers and are amplified using primers from, for example, a PCR kit for identity, including but not limited to, forensic human identification, paternity testing and cell line identification. Large STR databases for many different populations have been created for comparisons between and within a select segment of a population or a population, making STR-based nucleic acid identification widely accepted in the area of forensics, paternity testing and cell line identification, for example. STR-based nucleic acid identification, however, is not without limitations. In particular, degraded nucleic acid can be a problem for STR-based nucleic acid identification. For example, core unit repeat regions of certain STR alleles are longer than 200 base pairs (bp) in length. If a nucleic acid sample is degraded to 130 bp, analyzing these alleles would not provide informative data. Also, the mutation rate can be a problem for STR-based nucleic acid identification. In general, STRs have a mutation rate on the order of 1 in 1000. Consequently, the use of one set of STR markers can often not be enough to eliminate the possibility of mutations in the data. Therefore, there exists in the art a need for both additional polymorphic marker types as well as alternatives to STR polymorphic markers for the analyses of nucleic acids.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is a schematic diagram showing a system for calculating a predictive index of identity of a nucleic acid sample using polymorphic genetic marker data, in accordance with various embodiments.

FIG. 3 is an exemplary flowchart showing a method for calculating a predictive index of identity of a nucleic acid sample using a value from a second set of polymorphic genetic marker data that is not linked to a first set of polymorphic genetic marker data, in accordance with various embodiments.

FIG. 4 is an exemplary flowchart showing a method for calculating a predictive index of identity of a nucleic acid sample using a value from a second set of polymorphic genetic marker data that is linked to a first set of polymorphic genetic marker data, in accordance with various embodiments.

FIG. 5 is a schematic diagram of a system that includes one or more distinct software modules that performs a method for calculating a predictive index of identity of a nucleic acid sample using polymorphic genetic marker data, in accordance with various embodiments.

FIG. 6 is a schematic diagram showing a system for generating an identifier for a biological sample, in accordance with various embodiments.

FIG. 7 is an exemplary encoding of Mom Jane's identifier as both a string of characters and numbers and a two-dimensional barcode, in accordance with various embodiments.

FIG. 8 is a flowchart showing a method for generating an identifier for a biological sample, in accordance with various embodiments.

FIG. 9 is a schematic diagram of a system that includes one or more distinct software modules that performs a method for generating an identifier for a biological sample, in accordance with various embodiments.

FIG. 10 is a schematic diagram showing a system for verifying a relationship between a biological sample and an identifier, in accordance with various embodiments.

FIG. 11 is a flowchart showing a method for verifying a relationship between a biological sample and an identifier, in accordance with various embodiments.

FIG. 12 is a schematic diagram of a system that includes one or more distinct software modules that performs a method for verifying a relationship between a biological sample and an identifier, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

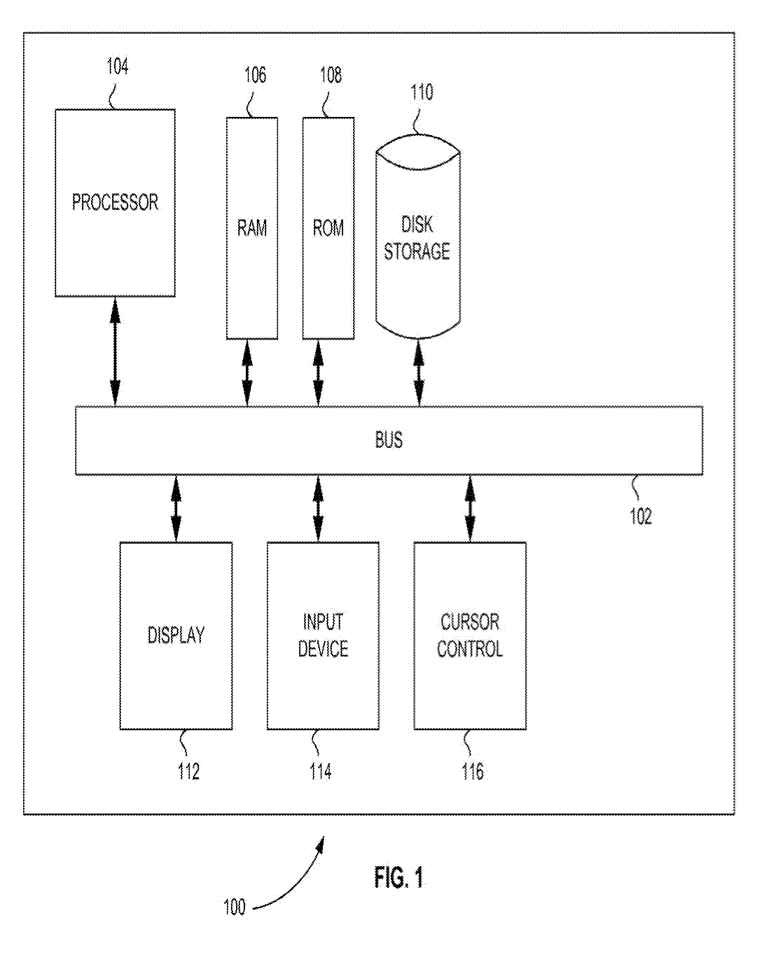

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for determining base calls, and instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively hard-wired circuitry may be used in place of or in combination with software instructions to implement the present teachings. Thus implementations of the present teachings are not limited to any specific combination of hardware circuitry and software.

In various embodiments, two or more computer systems that share one or more components of the architecture of computer 100 can perform the present teachings. These two or more computer systems can be in communication or networked. In various embodiments, these two or more computer systems can include a client/server or cloud computing architecture.

In various embodiments, computer system 100 can be a standalone system connected to laboratory instrumentation, or computer system 100 can be the computer system of a laboratory instrument or portable instrument.

The term “computer-readable medium” as used herein refers to any medium that participates in providing instructions to processor 104 for execution. Such a medium may take many forms, including but not limited to, non-volatile medium, volatile medium, and transmission medium. Non-volatile medium includes, for example, optical or magnetic disks, such as storage device 110. Volatile medium includes dynamic memory, such as memory 106. Transmission medium includes coaxial cables, copper wire, and fiber optics, including the wires that comprise bus 102.

Common forms of computer-readable medium include, for example, a floppy disk, a flexible disk, hard disk, solid-state drive (SSD), magnetic tape, or any other magnetic medium, a CD-ROM, any other optical medium, punch cards, papertape, any other physical medium with patterns of holes, a RAM, PROM, and EPROM, a FLASH-EPROM, any other memory chip or cartridge, or any other tangible medium from which a computer can read.

Various forms of computer readable medium may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a non-transitory and tangible computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Genetic Analysis Instrument

In some embodiments PCR amplification products can be detected by a method selected from microfluidics, electrophoresis, mass spectrometry and the like known to one of skill in the art for detecting amplification products.

In some embodiments, PCR amplification products may be detected by fluorescent dyes conjugated to the PCR amplification primers, for example as described in PCT patent application WO 2009/059049. PCR amplification products can also be detected by other techniques, including, but not limited to, the staining of amplification products, e.g. silver staining and the like.

In some embodiments, detecting comprises an instrument, i.e., using an automated or semi-automated detecting means that can, but needs not, comprise a computer algorithm. In some embodiments, the instrument is portable, transportable or comprises a portable component which can be inserted into a less mobile or transportable component, e.g., residing in a laboratory, hospital or other environment in which detection of amplification products is conducted. In certain embodiments, the detecting step is combined with or is a continuation of at least one amplification step, one sequencing step, one isolation step, one separating step, for example but not limited to a capillary electrophoresis instrument comprising at least one fluorescent scanner and at least one graphing, recording, or readout component; a chromatography column coupled with an absorbance monitor or fluorescence scanner and a graph recorder; a chromatography column coupled with a mass spectrometer comprising a recording and/or a detection component; a spectrophotometer instrument comprising at least one UV/visible light scanner and at least one graphing, recording, or readout component; a microarray with a data recording device such as a scanner or CCD camera; or a sequencing instrument with detection components selected from a sequencing instrument comprising at least one fluorescent scanner and at least one graphing, recording, or readout component, a sequencing by synthesis instrument comprising fluorophore-labeled, reversible-terminator nucleotides, a pyrosequencing method comprising detection of pyrophosphate (PPi) release following incorporation of a nucleotide by DNA polymerase, pair-end sequencing, polony sequencing, single molecule sequencing, nanopore sequencing, and sequencing by hybridization or by ligation as discussed in Lin, B. et al. “Recent Patents on Biomedical Engineering (2008)1(1)60-67, incorporated by reference herein.

In certain embodiments, the detecting step is combined with an amplifying step, for example but not limited to, real-time analysis such as Q-PCR. Exemplary means for performing a detecting step include the ABI PRISM® Genetic Analyzer instrument series, the ABI PRISM® DNA Analyzer instrument series, the ABI PRISM® Sequence Detection Systems instrument series, and the Applied Biosystems Real-Time PCR instrument series (all from Applied Biosystems); and microarrays and related software such as the Applied Biosystems microarray and Applied Biosystems 1700 Chemiluminescent Microarray Analyzer and other commercially available microarray and analysis systems available from Affymetrix, Agilent, and Amersham Biosciences, among others (see also Gerry et al., J. Mol. Biol. 292:251-62, 1999; De Bellis et al., Minerva Biotec 14:247-52, 2002; and Stears et al., Nat. Med. 9:140-45, including supplements, 2003) or bead array platforms (Illumina, San Diego, Calif.). Exemplary software includes GeneMapper™ Software, GeneScan® Analysis Software, and Genotyper® software (all from Applied Biosystems).

In some embodiments, an amplification product can be detected and quantified based on the mass-to-charge ratio of at least a part of the amplicon (m/z). For example, in some embodiments, a primer comprises a mass spectrometry-compatible reporter group, including without limitation, mass tags, charge tags, cleavable portions, or isotopes that are incorporated into an amplification product and can be used for mass spectrometer detection (see, e.g., Haff and Smirnov, Nucl. Acids Res. 25:3749-50, 1997; and Sauer et al., Nucl. Acids Res. 31:e63, 2003). An amplification product can be detected by mass spectrometry. In some embodiments, a primer comprises a restriction enzyme site, a cleavable portion, or the like, to facilitate release of a part of an amplification product for detection. In certain embodiments, a multiplicity of amplification products are separated by liquid chromatography or capillary electrophoresis, subjected to ESI or to MALDI, and detected by mass spectrometry. Descriptions of mass spectrometry can be found in, among other places, The Expanding Role of Mass Spectrometry in Biotechnology, Gary Siuzdak, MCC Press, 2003.

In some embodiments, detecting comprises a manual or visual readout or evaluation, or combinations thereof. In some embodiments, detecting comprises an automated or semi-automated digital or analog readout. In some embodiments, detecting comprises real-time or endpoint analysis. In some embodiments, detecting comprises a microfluidic device, including without limitation, a TaqMan® Low Density Array (Applied Biosystems). In some embodiments, detecting comprises a real-time detection instrument. Exemplary real-time instruments include, the ABI PRISM® 7000 Sequence Detection System, the ABI PRISM® 7700 Sequence Detection System, the Applied Biosystems 7300 Real-Time PCR System, the Applied Biosystems 7500 Real-Time PCR System, the Applied Biosystems 7900 HT Fast Real-Time PCR System (all from Applied Biosystems); the LightCycler™ System (Roche Molecular); the Mx3000P™ Real-Time PCR System, the Mx3005P™ Real-Time PCR System, and the Mx4000® Multiplex Quantitative PCR System (Stratagene, La Jolla, Calif.); and the Smart Cycler System (Cepheid, distributed by Fisher Scientific). Descriptions of real-time instruments can be found in, among other places, their respective manufacturer's user's manuals; McPherson; DNA Amplification: Current Technologies and Applications, Demidov and Broude, eds., Horizon Bioscience, 2004; and U.S. Pat. No. 6,814,934.

In some embodiments, detecting by sequencing comprises methods selected from Sanger sequencing, Maxam-Gilbert sequencing and variations thereof utilizing capillary or gel electrophoresis. Exemplary capillary electrophoresis instruments include, the ABI PRISM® 310 Genetic Analyzer, Applied Biosystems 3130 and 3130 xl Genetic Analyzers, the Applied Biosystems 3500/3500xL Genetic Analyzers, the Applied Biosystems 3730/3730xl DNA Analyzers (Applied Biosystems), Beckman CEQ 8000 Genetic Analyzer (Beckman Coulter) and MegaBACE 4000 DNA Sequencer (GE Healthcare) as well as next-generation sequencing technologies. Exemplary sequencing by synthesis instruments include the Genome Analyzer System (Solexa/Illumina Inc.), the Genome Sequence 20 System and the Genome Sequencer FLX Systems (454 Life Sciences/Roche Diagnostics) for pyrosequencing; sequencing by ligation using the SOLiD System (Applied Biosystems/Life Technologies); sequencing by hybridization; single molecule DNA sequencing, for example the Personal Genome Machine (Ion Torrent/Life Technologies); nanopore sequencing and polony sequencing and the like known to one of skill in the art for detecting and analyzing the sequenced nucleic acid. Further descriptions of next-generation sequencing can be found in Zhang, J., J. Genet. Genomics (2011) 38(3):95-109, Metzker, M. L. Nature Reviews Genetics (2010) 11:31-46 and Voelkerding, K. V. et al. Clinical Chemistry (2009) 55(4):641-658. Further information on single molecule sequence can be found in PCT publication WO2010/111674 and US Publication Numbers 2009/002608 and 2010/0137143, hereby incorporated by reference into this application. Those in the art understand that the detection techniques employed are generally not limiting. Rather, a wide variety of detection means are within the scope of the disclosed methods and kits, provided that they allow the presence or absence of a microorganism in the sample to be determined.

### Systems and Methods of Data Processing

### Identification

As described above, STR-based nucleic acid identification is currently the most widely accepted method of nucleic acid identification in forensics. STR-based nucleic acid identification, however, can be limited by degraded nucleic acid and the mutation rate of the STRs used, e.g., an STR can mutate from parent to child when utilized in paternity testing, for example.

The term “polymorphism” as used herein refers to the occurrence of two or more alternative genomic sequences or alleles between or among different genomes or individuals. “Genetic polymorphism” herein indicates that two or more forms of an allele exist on a particular segment of genomic DNA with a certain frequency. A gene locus may be any region on the genome, and is not limited to the genetic region which is expressed. A short tandem repeat (STR) refers to a short sequence that varies between alleles by the number of repeats of the sequence present, e.g., the polymorphism is due to variation in the number of repeats across different allelic forms.

An STR is one type of genetic polymorphism. Other types of genetic polymorphisms can include, but are not limited to, insertions or deletions (indels) or single nucleotide polymorphisms (SNPs). An indel as used herein is a length polymorphism created by the insertion or deletion of one or more nucleotides in a locus within the genome of an organism. An indel is preferably biallelic. A locus can have more than one indel polymorphism. In contrast, a SNP as used herein is a single nucleotide polymorphism (e.g., A/T or T/A) in a locus within the genome of an organism. A locus can have more than one SNP. A SNP is an example of a biallelic allele and an STR is often multiallelic due to variation in the number of repeated units occurring in tandem within a locus.

The term “genetically matched” as used herein refers to the nucleic acid sequence on a particular segment of genomic DNA, for example, the nucleic acid sequence comprising an STR, an insertion/deletion or SNP within a genetic locus. The nucleic acid sequence of a highly variable repeat or polymorphic region will exhibit a nucleic acid sequence match between closely related individuals but would not exhibit a nucleic acid sequence match when compared to non-related individuals.

The term “biometrically matched” as used herein refers to a match between an identified organism's physiological characteristic, including but not limited to, the fingerprint, palm print, hand geometry, face recognition, iris or retina recognition, odor/scent recognition and DNA when compared to the same physiological biometric characteristic of an unidentified organism.

In various embodiments, for a nucleic acid sample, data from two or more sets of polymorphic genetic markers are combined in order to eliminate or reduce the limitations of nucleic acid identification based on a single set of polymorphic genetic markers, such as STR markers. The two or more sets of polymorphic genetic markers can include any combination of polymorphic genetic markers. For example, the two or more sets of polymorphic genetic markers can include, but is not limited to, two sets of STR markers or one set of STR markers and one set of indel markers or one set of STR markers or SNP markers and one set of indel markers and combinations thereof.

In various embodiments, the data from two or more sets of polymorphic genetic markers can be combined to add to the data from one of the two or more sets of polymorphic genetic markers.

In various embodiments, the data from two or more sets of polymorphic genetic markers can also be combined to replace a missing portion of the data from one of the two or more sets of polymorphic genetic markers. If a nucleic acid sample is degraded, a data value for a polymorphic genetic marker from an initial set of polymorphic genetic markers may not be found or may not be usable, for example. A data value of a polymorphic genetic marker from an additional set of polymorphic genetic markers, however, can be used to replace the missing or unusable value.

Non-STR polymorphic genetic markers, such as indels, can be detected in amplicons that are about 30 bp, about 40 bp, about 50 bp, to about 90 bp in length. Such amplicons are well suited for degraded nucleic acid isolated as from aged or environmentally damaged biological samples containing nucleic acid, telogen hair, old bones and decayed samples. As a result, in various embodiments, combining non-STR polymorphic genetic markers, such as indels, with traditional STR-based nucleic acid identification can improve the performance of the identification for degraded nucleic acid samples.

Similarly, non-STR polymorphic genetic markers, such as indels and SNPs, have a mutation rate on the order of 1 in 100,000,000. Therefore, mutations occur in indels and SNPs 100,000 times less frequently than in STRs. Indel and SNP mutation rates are useful in cases of paternity.

In various embodiments, both indels and SNPs can be used to improve STR-based nucleic acid identification. They both have similar advantages for handling degraded nucleic acid and improving the overall mutation rate. SNP detection, however, can be more complex than indel detection. SNP analysis is more time consuming and can require a more complex workflow, additional reagents and laboratory equipment. A typical set of STRs includes on the order of 20 markers representing 20 different genomic regions. A typical set of indels markers can include on the order of 20, of 30, of 40, of 50, of 60, of 70 or more markers for different genomic regions.

Although advantageous, combining data from two or more sets of polymorphic genetic markers is not without difficulty. Any linkage or overlap between two or more sets of polymorphic genetic markers must be taken into account. As used herein, there is a linkage between two polymorphic genetic markers from two different sets of polymorphic genetic markers if the two polymorphic genetic markers are each from regions of a nucleic acid that remain together even after the nucleic acid biologically rearranges. In other words, linked polymorphic genetic markers would provide redundant information. As a result, the product rule for calculating probability of identity can no longer apply.

In various embodiments, the linkage between two or more sets of polymorphic genetic markers is taken into account in adding to or replacing a missing portion of the data from one of the two or more sets of polymorphic genetic markers. In one embodiment, this linkage information is used to exclude data from being added or replaced. In another embodiment, this linkage information is used to find data used to replace missing data.

In a first example, linkage information is used to exclude data and avoid multiple-counting of linked markers while selecting the marker with the highest PI value for human identity samples. A first set of data is obtained from a nucleic acid that includes usable values for all of the polymorphic genetic markers in a first set of polymorphic genetic markers. A value is, for example, a measurement. A usable value is, for example, a value that exceeds a certain threshold for use in identification. If any putative mutation identified among the first set of polymorphic genetic markers for a particular type of identification is unusable for a particular polymorphic genetic marker, a second set of data is obtained from the same nucleic acid using a second set of polymorphic genetic markers. In order to avoid the double counting problem mentioned above, linkage information between the first set of polymorphic genetic markers and the second set of polymorphic genetic markers is used to exclude certain usable values from the second set of data. Specifically, a usable value from a polymorphic genetic marker from the second set of data is excluded from being combined with the first set of usable data, if the polymorphic genetic marker is linked to any polymorphic genetic marker in the first set of polymorphic genetic markers.

In a second example, linkage information is used to exclude data from being used to replace missing data. A first set of data is obtained from a nucleic acid that does not include a usable value for all of the polymorphic genetic markers in a first set of polymorphic genetic markers. A usable value for a polymorphic genetic marker may not have been found in the first set of data, because for example, a portion of the nucleic acid was too degraded. A second set of data is then obtained from the same nucleic acid using a second set of polymorphic genetic markers. Again, in order to avoid the double counting problem, linkage information between the first set of polymorphic genetic markers and the second set of polymorphic genetic markers is used to exclude certain usable values from the second set of data that would be used to replace the missing portion of the first set of data. In other words, only usable values from the second set of data linked to markers failing to provide useable values in the first set of data would be selected for determining the PI value. Specifically, a usable value from a polymorphic genetic marker from the second set of data is excluded from being combined with the first set of data, if the polymorphic genetic marker is linked to any polymorphic genetic marker in the first set of polymorphic genetic markers that produced a usable value in the first set of data.

In a third example, linkage information is used to find data used to replace missing data. A first set of data is obtained from a nucleic acid that does not include a usable value for all of the polymorphic genetic markers in a first set of polymorphic genetic markers. A polymorphic genetic marker that does not have a usable value is selected from the first set of polymorphic genetic markers. A second set of data is then obtained from the same nucleic acid using a second set of polymorphic genetic markers. Linkage information between the first set of polymorphic genetic markers and the second set of polymorphic genetic markers is used to find a polymorphic genetic marker from the second set of polymorphic genetic markers that is linked to the selected polymorphic genetic marker from the first set of polymorphic genetic markers. If such a polymorphic genetic marker is found in the second set of polymorphic genetic markers and this polymorphic genetic marker has a usable value, then this usable value is used to replace the missing value in the first set of data.

### Identification System

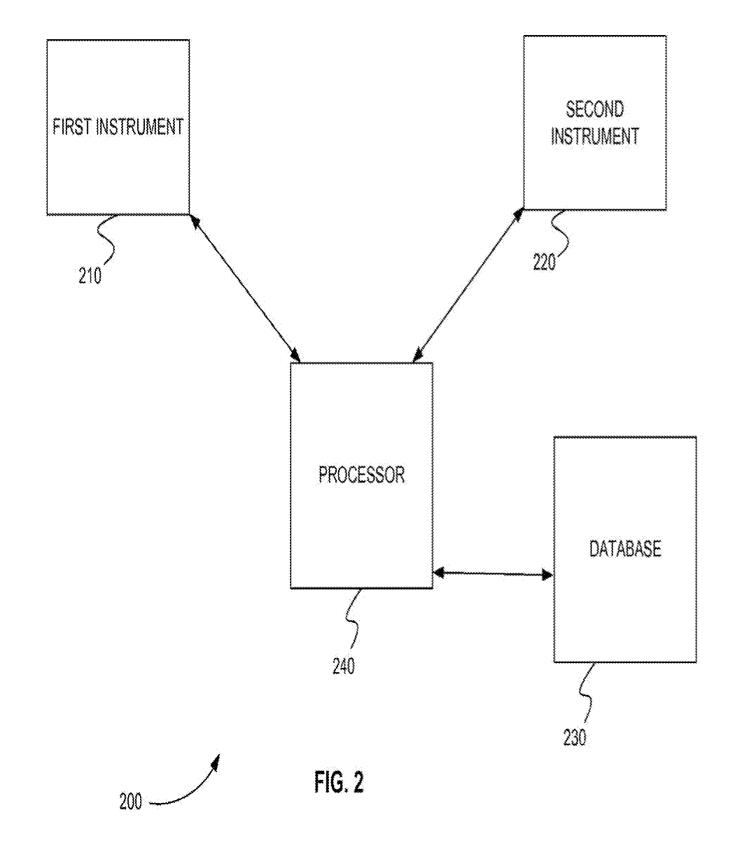

FIG. 2 is a schematic diagram showing a system 200 for calculating a predictive index of identity of a nucleic acid sample using polymorphic genetic marker data, in accordance with various embodiments. System 200 includes first instrument 210, second instrument 220, database 230, and processor 240. First instrument 210 or second instrument 220 can include, but is not limited to, a capillary electrophoresis instrument or a mass spectrometer. In various embodiments, first instrument 210 and second instrument 220 are the same instrument.

Database 230 can be, but is not limited to, a magnetic disk drive, an electronic memory, a random access memory (RAM), a read only memory (ROM), or an optical disk drive. Database 230 is shown in FIG. 2 as a separate device. In various embodiments, database 230 can be an internal memory of processor 240, first instrument 210 or second instrument 220. Database 230 is shown in FIG. 2 as directly connected to processor 240. In various embodiments, database 230 can be connected to processor 240 through a network, or database 230 can be connected to first instrument 210 or second instrument 220 directly or through a network.

Processor 240 can be, but is not limited to, a computer, microprocessor, or any device capable of sending and receiving control signals and data to and from database 230, first instrument 210, and second instrument 220. Processor 240 is shown in FIG. 2 as a separate device. In various embodiments, processor 240 can be an internal processor of database 230, first instrument 210 or second instrument 220.

In various embodiments, first instrument 210 analyzes a nucleic acid sample and produces a first set of data from a first set of polymorphic genetic markers for the nucleic acid sample. Second instrument 220 analyzes the same nucleic acid sample and produces a second set of data from a second set of polymorphic genetic markers for the nucleic acid sample.

In various embodiments, the first set of polymorphic genetic markers and the second set of polymorphic genetic markers are the same type of polymorphic genetic markers. In various embodiments, the first set of polymorphic genetic markers and the second set of polymorphic genetic markers are different types of polymorphic genetic markers. The types of polymorphic genetic markers can include, but are not limited to, STRs, indels, or SNPs.

Database 230 provides linkage information between the first set of polymorphic genetic markers and the second set of polymorphic genetic markers.

Processor 240 is in communication with first instrument 210, second instrument 220, and database 230. Processor 240 receives the first set of data from first instrument 210, the second set data from second instrument 220, and the linkage information from database 230.

In one embodiment, system 200 is used to replace an unusable value in a first set of data or add a value to the first set of data using a value that comes from a polymorphic genetic marker that is not linked to any of the polymorphic genetic markers with usable data in the first set of data. Processor 240 selects a usable value for a polymorphic genetic marker from the second set of data. Processor 240 searches the linkage information of database 230 for the polymorphic genetic marker. Processor 240 determines that the polymorphic genetic marker is not linked to any of the polymorphic genetic markers in the first set of data that have usable values. Finally, processor 240 calculates a predictive index of identity based on the usable values in the first set of data and the usable value for the polymorphic genetic marker from the second set of data.

In various embodiments, the usable value for the polymorphic genetic marker from the second set of data replaces an unusable value in the first set of data in the calculation of the predictive index of identity. In various embodiments, the usable value for the polymorphic genetic marker from the second set of data provides a value that is in addition to the values in the first set of data in the calculation of the predictive index of identity.

In another embodiment, system 200 is used to replace an unusable value in a first set of data using a value that comes from a polymorphic genetic marker that is linked to the polymorphic genetic marker of the unusable data in the first set of data. Processor 240 determines that the first set of data includes at least one unusable first value for a first polymorphic genetic marker of the first set of polymorphic genetic markers. Processor 240 searches the linkage information of database 230 for a second polymorphic genetic marker that is linked to the first polymorphic genetic marker. Processor 240 determines that a second usable value for the second polymorphic genetic marker is in the second set of data. Finally, processor 240 calculates a predictive index of identity based on usable values from the first set of data and the second usable value from the second set of data.

### Identification Methods

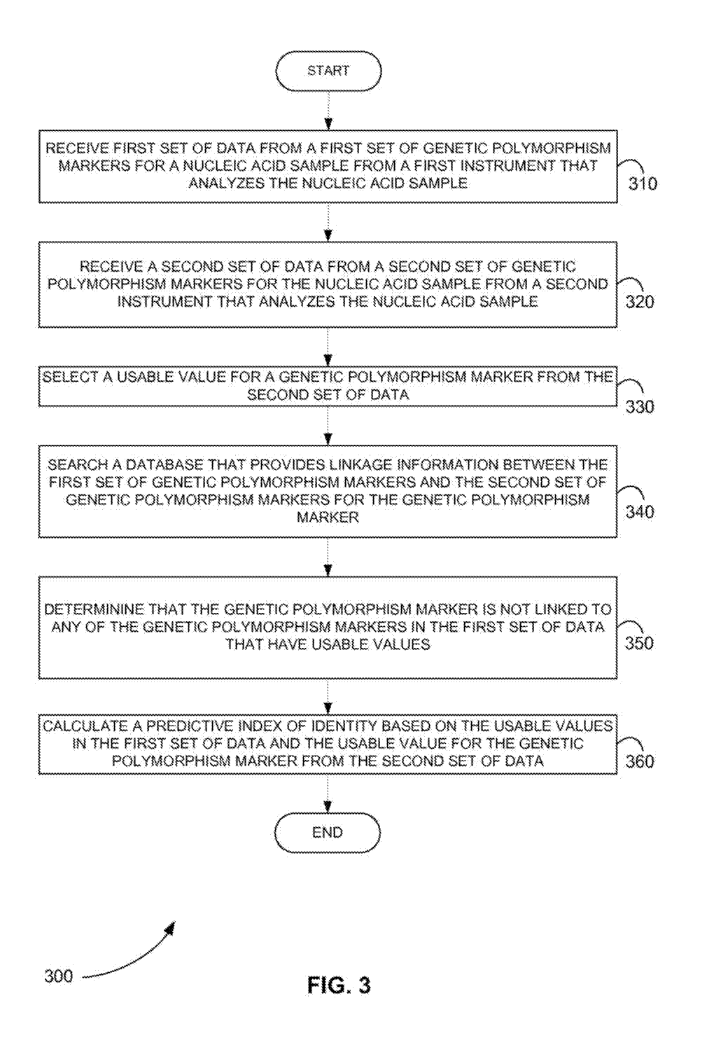

FIG. 3 is an exemplary flowchart showing a method 300 for calculating a predictive index of identity of a nucleic acid sample using a value from a second set of polymorphic genetic marker data that is not linked to a first set of polymorphic genetic marker data, in accordance with various embodiments.

In step 310 of method 300, a first set of data from a first set of polymorphic genetic markers for a nucleic acid sample is received from a first instrument that analyzes the nucleic acid sample.

In step 320, a second set of data from a second set of polymorphic genetic markers for the nucleic acid sample is received from a second instrument that analyzes the nucleic acid sample.

In step 330, a usable value for a polymorphic genetic marker is selected from the second set of data.

In step 340, a database that provides linkage information between the first set of polymorphic genetic markers and the second set of polymorphic genetic markers is searched for the polymorphic genetic marker.

In step 350, it is determined that the polymorphic genetic marker is not linked to any of the polymorphic genetic markers in the first set of data that have usable values.

In step 360, a predictive index of identity is calculated based on the usable values in the first set of data and the usable value for the polymorphic genetic marker from the second set of data.

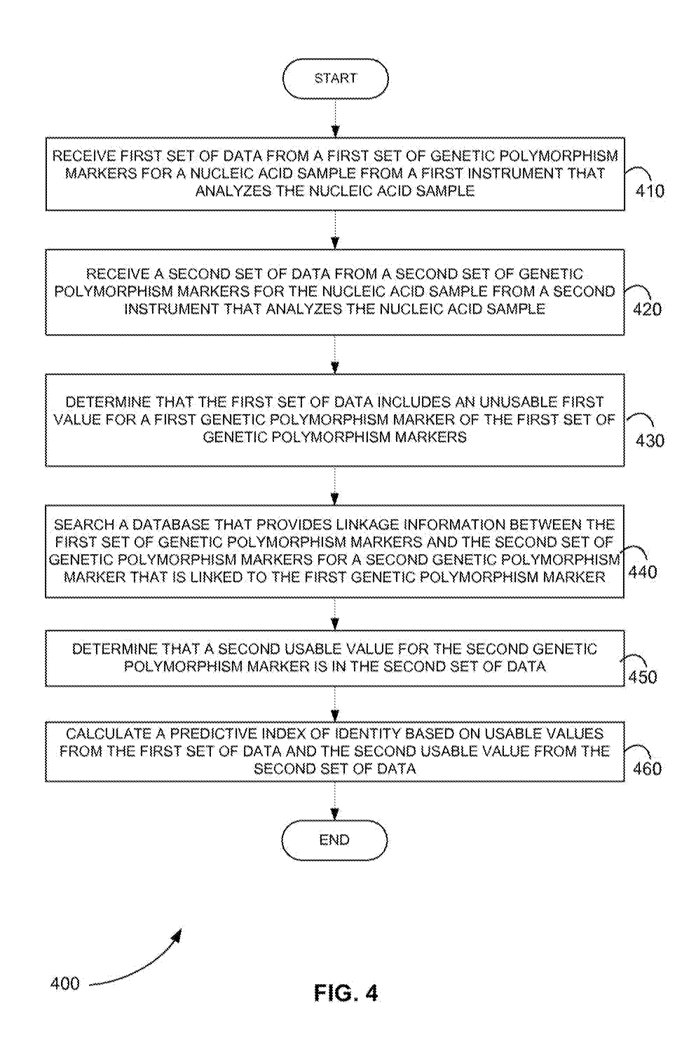

FIG. 4 is an exemplary flowchart showing a method 400 for calculating a predictive index of identity of a nucleic acid sample using a value from a second set of polymorphic genetic marker data that is linked to a first set of polymorphic genetic marker data, in accordance with various embodiments.

In step 410 of method 400, a first set of data from a first set of polymorphic genetic markers for a nucleic acid sample is received from a first instrument that analyzes the nucleic acid sample.

In step 420, a second set of data from a second set of polymorphic genetic markers for the nucleic acid sample is received from a second instrument that analyzes the nucleic acid sample.

In step 430, it is determined that the first set of data includes an unusable first value for a first polymorphic genetic marker of the first set of polymorphic genetic markers.

In step 440, a database that provides linkage information between the first set of polymorphic genetic markers and the second set of polymorphic genetic markers is searched for a second polymorphic genetic marker from the second set of genetic polymorphism markers that is linked to the first polymorphic genetic marker.

In step 450, it is determined that a usable value for the second polymorphic genetic marker is in the second set of data.

In step 460, a predictive index of identity is calculated based on usable values from the first set of data and the second usable value for the alternative genetic polymorphism marker from the second set of data.

### Identification Computer Program Product

In various embodiments, a computer program product includes a non-transitory and tangible computer-readable storage medium whose contents include a program with instructions being executed on a processor so as to perform a method for calculating a predictive index of identity of a nucleic acid sample using polymorphic genetic marker data. This method is performed by a system that includes one or more distinct software modules.

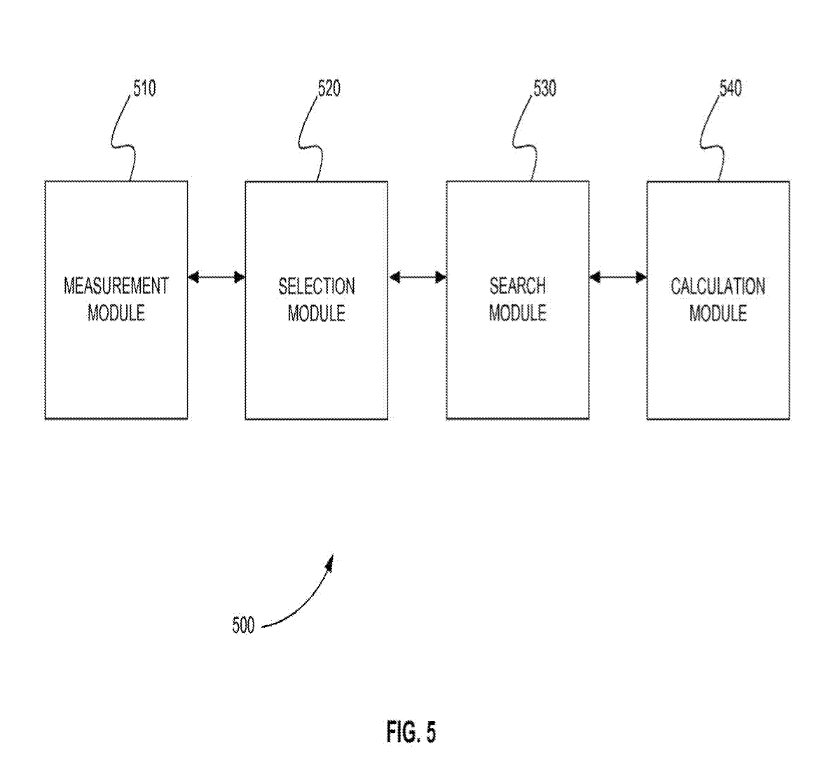

FIG. 5 is a schematic diagram of a system 500 that includes one or more distinct software modules that performs a method for calculating a predictive index of identity of a nucleic acid sample using polymorphic genetic marker data, in accordance with various embodiments. System 500 includes measurement module 510, selection module 520, search module 530, and calculation module 540.

Measurement module 510 receives a first set of data from a first set of polymorphic genetic markers for a nucleic acid sample from a first instrument that analyzes the nucleic acid sample. Measurement module 510 receives a second set of data from a second set of polymorphic genetic markers for the nucleic acid sample from a second instrument that analyzes the nucleic acid sample.

In one embodiment, system 500 is used to replace an unusable value in a first set of data or add a value to the first set of data using a value that comes from a polymorphic genetic marker in a second set of data that is not linked to any of the polymorphic genetic markers with usable data in the first set of data. Selection module 520 selects a usable value for a polymorphic genetic marker from the second set of data. Search module 530 searches a database that provides linkage information between the first set of polymorphic genetic markers and the second set of polymorphic genetic markers for the polymorphic genetic marker value to be replaced or added. Search module 530 also determines that the polymorphic genetic marker value to be replaced or added is not linked to any of the polymorphic genetic markers in the first set of data that have usable values. Calculation module 540 calculates a predictive index of identity based on the usable values in the first set of data and the usable value for the polymorphic genetic marker from the second set of data.

In another embodiment, system 500 is used to replace an unusable value in a first set of data using a value that comes from a polymorphic genetic marker that is linked to the polymorphic genetic marker of the unusable data in the first set of data. Selection module 520 determines that the first set of data includes an unusable first value for a first polymorphic genetic marker of the first set of polymorphic genetic markers using the selection module. Search module 530 searches a database that provides linkage information between the first set of polymorphic genetic markers and the second set of polymorphic genetic markers for a second polymorphic genetic marker that is linked to the first polymorphic genetic marker using the search module. Search module 530 also determines that a second usable value for the second polymorphic genetic marker is in the second set of data using the search module. Calculation module 540 calculates a predictive index of identity based on usable values from the first set of data and the second usable value from the second set of data using the calculation module.

### Identifier for a Biological Sample

In various embodiments, polymorphic genetic markers are used to create an identifier for a biological sample. The identifier is an encoding of the genome content of the biological sample; for example. The identifier can be, but is not limited to, a string of numbers and/or characters, a barcode, or any other representation of a set of values for polymorphic genetic markers. The set of values for polymorphic genetic markers are produced from an analysis that identifies the genome content of a nucleic acid of the biological sample.

### Identifier Generation System

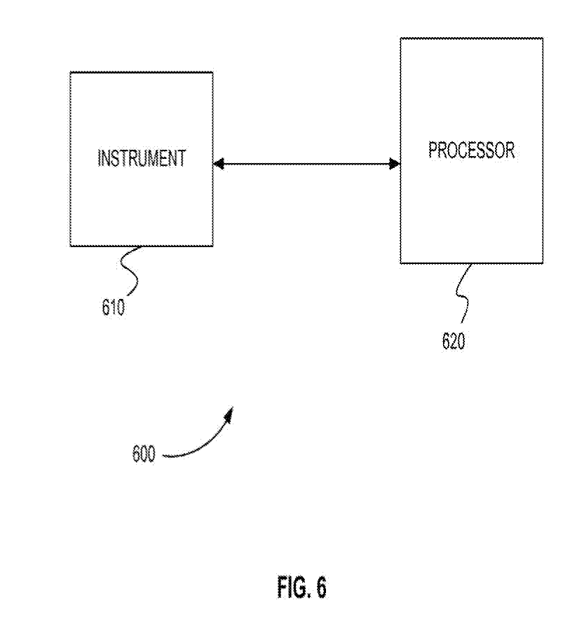

FIG. 6 is a schematic diagram showing a system 600 for generating an identifier for a biological sample, in accordance with various embodiments. System 600 includes instrument 610 and processor 620. Instrument 610 analyzes a nucleic acid from a biological sample. Instrument 610 produces a set of values for polymorphic genetic markers from the analysis that identifies the genome content of the biological sample.

Processor 620 is in communication with the instrument. Processor 620 receives the set of values for polymorphic genetic markers from instrument 610. Processor 620 encodes the set values for polymorphic genetic markers into an identifier for the biological sample

A polymorphic genetic marker can include, but is not limited to, a short tandem repeat (STR), an indel, or a single nucleotide polymorphism (SNP). Processor 620 can encode the set values for polymorphic genetic markers into an identifier using an encryption algorithm, for example.

In various embodiments, system 600 can also include an output device (not shown). The output device can include any output device or storage device of a computer or instrument, for example. The output device can store the identifier on a tangible readable medium, for example. A tangible readable medium can include, but is not limited to, a tangible computer-readable storage medium, a label, a bracelet, an integrated circuit or microchip, a necklace, a dog tag, a radio frequency identification (RFID) tag, a hospital bracelet, a driver's license, a military identification, a toe tag, or any other piece of identification. The output device can also store the identifier with an associated identifier on the tangible readable medium, for example. An associated identifier can include a name, for example.

Some biological samples can be from different sources but can have the same set of values for polymorphic genetic markers. For example, identical twins can have the same set of values for polymorphic genetic markers.

In various embodiments, biometric information can be added to an identifier of a biological sample. For example, system 600 can include a biometric reader (not shown) that reads a biometric parameter associated with the biological sample. A biometric reader can include, but is not limited to, a retina scanner or a fingerprint reader. Processor 620 then encodes the biometric parameter with the set of values for polymorphic genetic markers into the identifier for the biological sample.

### Cell Line Authentication

Cell lines are important tools for biological research. Studies however, have indicated that as many as 16% of the cell lines used in research or donated to the cell bank were either misidentified or contaminated. Cross contamination in cell culture or cell identity mix-ups may invalidate data interpretation and render research worthless. There is a need to establish a simple, cheap, quick, and reliable technique for authenticating cell lines.

Indel profiling uses multiplex PCR to simultaneously amplify a set of informative polymorphic markers in the human genome. The pattern of data output results in a unique Indel identity profile for each cell line analyzed. The profiles of standard cell lines can be used as a baseline for comparison with cell line samples of interest to verify cell identity or cross-contamination issues.

In various embodiments, a biological sample is from a cell line. System 600 generates an identifier that identifies the cell type of the cell line.

Plant Genus and/or Species Identification

Plant species identification techniques are frequently used in invasive/endangered species management, quarantine, forensic trace evidence analysis, cultivar characterization, identification of herb ingredients and tracking of food products derived from plants, for example. Traditional taxonomic approaches usually require highly skilled personnel to examine physical characteristics of various plant parts collected from different growth stages. But that does not always work in practical applications. Often analysts may only have a small piece of plant materials to work with. Multiplex indel assays introduce the possibility of utilizing nucleic acid sequence variations for fast plant species identification with a very limited amount of plant materials. In addition, multiplex indel assays with appropriate marker selection provide a valuable tool to distinguish closely related or morphologically similar plants that may otherwise be difficult or impossible to achieve.

To set up multiplex indel assays for plant identification, nucleic acid samples obtained from plant materials of interest are amplified using PCR reagents containing multiple sets of sequence-specific primers. Genotypes of multiple indel loci are determined based on length variations of PCR amplicons resolved by gel or capillary electrophoresis, for example. The identification of a plant species is then achieved by matching the indel genotype profile to a reference whose classification have been determined and validated.

In various embodiments, a biological sample is from a plant. System 600 generates an identifier that identifies the plant species of the plant.

### Mother/Child Relationship

In various embodiments, a biological sample is from an organism and system 600 generates an identifier that identifies the organism enough to determine a mother/child relationship with another organism. For example, nucleic acid samples obtained from individuals (a mother and a child) are first processed with multiplex indel analysis. The resulting genotype data is converted into an identifier using system 600 and can include a specific format as a multi-digit string/number. Each digit in the string represents the genotype code of a specific indel marker. The order of genotype codes in the string are consistent with the specific order of bi-allelic markers analyzed. The conversion from conventional genotype calls (e.g. Deletion/Deletion, Insertion/Insertion, Deletion/Insertion) to multi-digit string/numbers is done using an encoding algorithm. Table 1 provides an example genotype code assignment for bi-allelic indel markers:

TABLE 1

| Genotype | Conventional Genotype |
|---|---|
| Code | Call |
| 1 | Deletion/Deletion |
| 2 | Insertion/Insertion |
| 3 | Deletion/Insertion |
| 4 | No call, off-bin allele, OL |

As a result, genotype data from an N-plex indel analysis produces an N-digit genotype code string/number containing N genotype codes or values. For example, Baby John's genotyping data of a 30-plex indel assay (N=30) is converted into the 30-digit genotype code string “321331113123231232321232123212.” Mom Jane's genotyping data is converted into the 30-digit genotype code string “331213132223321121323323133233.”

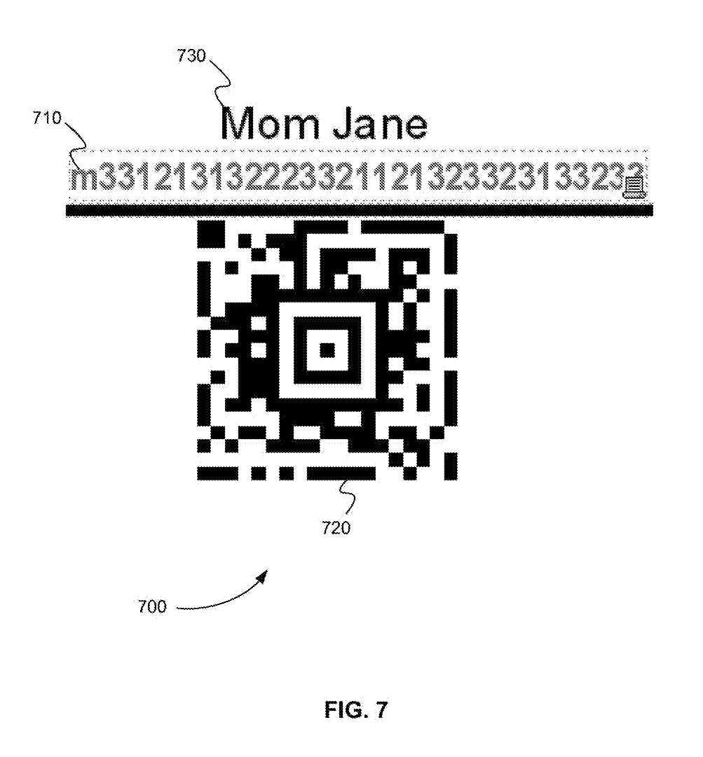

FIG. 7 is an exemplary encoding 700 of Mom Jane's identifier as both a string of characters and numbers 710 and a two-dimensional barcode 720, in accordance with various embodiments. Associated identifier, name “Mom Jane,” 730 is also shown stored with string of characters and numbers 710 and two-dimensional barcode 720 in FIG. 7. The information shown in FIG. 7 is stored on a hospital bracelet, for example.

To determine a sample match of a mother/child pair of identifiers, barcodes are scanned and converted back to N-digit strings, for example. Every indel marker analyzed needs to have at least one common allele between baby and mom in order to call a successful “profile match” or genetic match between a baby and a mom. To conduct a genotype profile comparison, each digit at a specific position of baby's genotype code string is compared to the digit in the corresponding position of mom's genotype code string. Table 2 lists all the possible combinations. Any occurrence of genotype code 4, the genotype code pair (baby=1, mom=2), or the pair (baby=2, mom=1) would fail in locus match. Successful locus match for all the markers tested would result in a successful “profile match” between a baby and a mom. The match between Baby John and Mom Jane fails because, at least, digit 10 is the code pair (baby=1, mom=2).

TABLE 2

| | |
|---|---|
| Genotype code | Locus |

| Baby | Mom | match |
|---|---|---|
| 1 | 1 | Yes |
| 1 | 2 | No |
| 1 | 3 | Yes |
| 2 | 1 | No |
| 2 | 2 | Yes |
| 2 | 3 | Yes |
| 3 | 1 | Yes |
| 3 | 2 | Yes |
| 3 | 3 | Yes |

### Paternity Relationship

In various embodiments, a biological sample is from an organism and system 600 generates an identifier that identifies the organism enough to determine a paternity relationship with another organism. For example, parental testing is the use of genotyping tests to determine whether two individuals have a biological parent-child relationship. During a paternity test, nucleic acid profiles are generated from biological samples collected from the mother, the child and one or more suspected fathers. The results of a routine paternity test will indicate a probability of paternity of either 0.00% or 99.9% or greater. The probability of paternity is converted from the “paternity index”, which is the likelihood ratio between the chances that the alleged father may pass the paternal gene, compared to the chance that a random man may pass the paternal gene to the child. If the paternity index is zero, it is because the father does not have any matching alleles with the child at that particular polymorphic genetic marker. This is called an “exclusion.” If the child and alleged father share the required polymorphic genetic markers, then the alleged father cannot be excluded as the biological father and a probability of paternity is calculated.

Table 3 provides an example of an inclusion result. The two alleles are identified for the child at each polymorphic generic marker (e.g., the child has a (D, I) at the polymorphic generic marker rs28923216). It is determined which of the child's alleles came from the mother (e.g., at the polymorphic generic marker rs28923216, the mother (I, I) gives the child (D, I) an I). Therefore the alleged father provides the child with the other allele, a D (e.g., at the polymorphic generic marker rs28923216, the alleged father (D, D) provides the child (D, I) with the D). 4. This matching between the child and alleged father at the polymorphic generic marker rs28923216 is an example of an inclusion. Once the alleles are analyzed for all the polymorphic genetic markers, population statistics are then calculated based upon allele frequency of the paternal alleles provided to the child. (See Table 3 for the calculation of paternity index (PI)). If each polymorphic generic marker tested is independent, the final calculation involves the multiplication of each paternity index with the others to come up with a combined paternity index value. For example, the paternity index of the polymorphic generic marker rs28923216 is 1.90 and the combined paternity index for the overall results is 38.77.

TABLE 3

| | | | Alleged | Paternity |
|---|---|---|---|---|
| Indel Marker | Mother | Child | Father | Index |
| rs34781304 | I, I | I, I | I, I | 1.25 |
| rs28923216 | I, I | D, I | D, D | 1.90 |
| rs2307700 | D, D | D, D | D, D | 1.92 |
| rs10629864 | I, I | I, I | D, I | 0.79 |
| rs1610907 | D, D | D, I | I, I | 2.50 |
| rs34510056 | I, I | I, I | I, I | 2.01 |
| rs2307507 | D, I | D, D | D, D | 2.14 |

Table 4 provides an example of an exclusion result. The two alleles are identified for the child (e.g., the child has a D, D at the polymorphic generic marker rs2308276). It is determined which of the child's alleles came from the mother (e.g., the polymorphic generic marker rs2308276, the mother (D,I) gives the child (D,D) a D). Therefore the biological father provides the child with the other allele, a D. However the tested alleged father is a I, I and could not have provided the child with a D. This mismatch between the child and alleged father at the polymorphic generic marker rs2308276 is an example of an exclusion and the paternity index is 0.00 for the polymorphic generic marker rs2308276. If the child and alleged father do match for some polymorphic generic markers, population statistics are used to derive a paternity index for those polymorphic generic markers. When the statistical calculations are applied to the all of the paternity index results in the above case, the combined paternity index is 0.00 and therefore there is a 0% probability of paternity.

TABLE 4

| | | | Alleged | Paternity |
|---|---|---|---|---|
| Indel Marker | Mother | Child | Father | Index |
| rs2308276 | D, I | D, D | I, I | 0 |
| rs3841948 | D, I | D, D | D, D | 2.29 |
| rs17515041 | D, I | I, I | I, I | 1.69 |
| rs2308057 | I, I | I, I | D, D | 0 |
| rs4149614 | I, I | D, I | D, I | 0.90 |

### Human Identification

In various embodiments, a biological sample is from an organism and system 600 generates an identifier that identifies the organism enough to determine an identity of the organism within a population. For example, a typical case of nucleic acid profiling for human identification applications involves the comparison of two samples—an unknown or evidence sample and a known or reference sample. If the set of values for polymorphic genetic markers does not match between two samples, the analyst can be sure that the two nucleic acid samples came from different sources. If the nucleic acid profiles obtained from the two samples are indistinguishable, a statistical calculation is made to determine the frequency with which this genotype is observed in the population. Such a probability calculation takes into account the frequency with which each allele occurs in the individual's ethnic group.

Consider the example shown in Table 5. A suspect sample and an evidence sample have the same alleles in the three indel loci tested. In Table 5, the alleles D and I of a locus occur in a population with frequencies of p and q, respectively. The probability of finding this specific 3-locus nucleic acid profile within a population is calculated by multiplying the probabilities provided by each locus assuming these loci are inherited independently of each other. Therefore, the expected profile frequency for the case shown in Table 5 is 0.053 (=0.47×0.71×0.16). This number is the probability of seeing this nucleic acid profile if the crime scene evidence did not come from the suspect but from some other person.

TABLE 5

| | | |
|---|---|---|
| | | Genotype |
| DNA profile | Allele | frequency |

| Indel Locus | Allele | Frequency | for the locus |
|---|---|---|---|
| rs10590424 | D | p = 0.6182 | 2pq = 0.47 |
| | I | q = 0.3818 | |
| rs1160936 | I | q = 0.8424 | q²⁼0.71 |
| | I | | |
| rs1611033 | D | p = 0.3939 | p²⁼0.16 |
| | D | | |

If two samples share very rare alleles, the likelihood that they came from the same source is increased. If the nucleic acid profile is not so rare, the suspect might be unrelated to the evidence, and the match is simply by chance.

The probability of identity (PI) of a given nucleic acid genotyping analysis method looks at the probability that two individuals selected at random from a population have the identical profiles. Its value can be estimated from allele frequencies in a population using established formula:

$$PI = {\sum }_{i = a}^{n} {\sum }_{j \geq 1}^{n} {P}_{ij}^{2}$$

where i and j represent the frequencies of all possible alleles a through n; Pij represents the frequencies of all possible genotypes. The combined matching probability for more than one locus is the product of the individual matching probability at each locus, assuming that these loci are not linked. If an analyst cites match probabilities of 10⁻¹⁵, for example, then it is very unlikely that two unrelated people can have complete match of nucleic acid profiles since there are less than 10¹⁰ people in the world.

### Identifier Generation Method

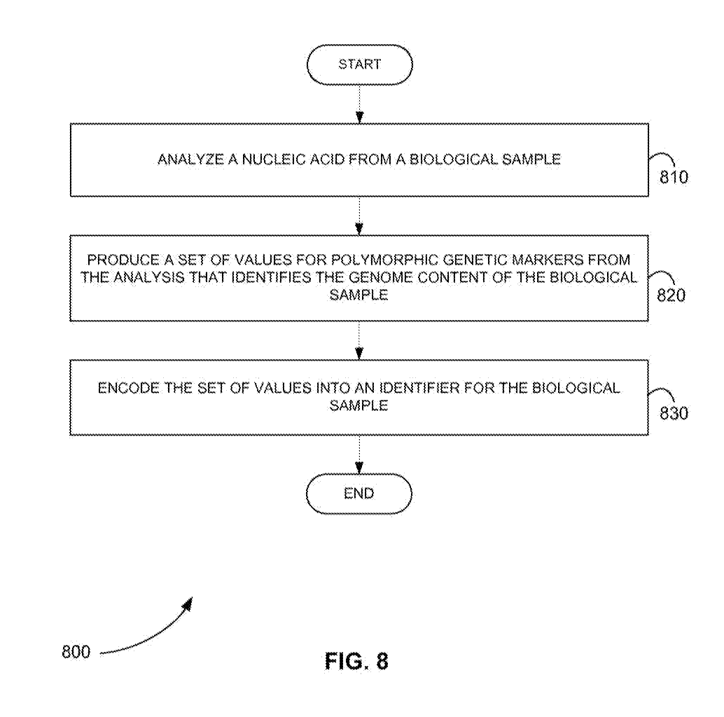

FIG. 8 is a flowchart showing a method 800 for generating an identifier for a biological sample, in accordance with various embodiments.

In step 810 of method 800, a nucleic acid from a biological sample is analyzed.

In step 820, a set of values for polymorphic genetic markers that identifies the genome content of the biological sample is produced from the analysis.

In step 830, the set of values for polymorphic genetic markers is encoded into an identifier for the biological sample.

### Identifier Generation Computer Program Product

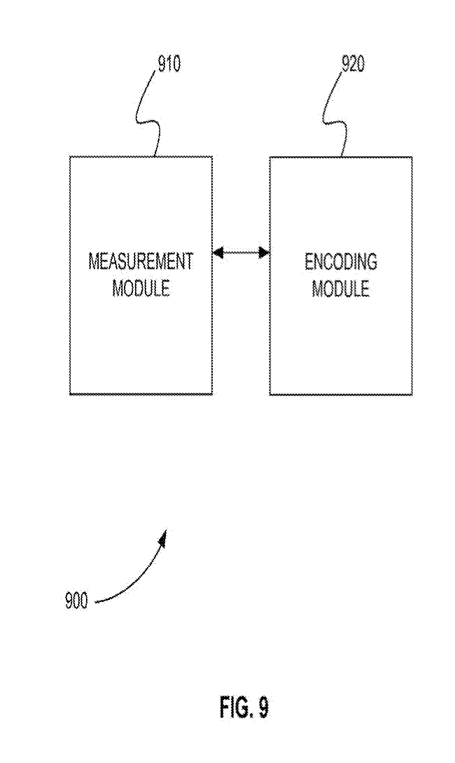

FIG. 9 is a schematic diagram of a system 900 that includes one or more distinct software modules that performs a method for generating an identifier for a biological sample, in accordance with various embodiments. System 900 includes measurement module 910 and encoding module 920.

Measurement module 910 receives a set of values for polymorphic genetic markers that identifies the genome content of a biological sample from a instrument. The instrument is used to analyze a nucleic acid of the biological sample and produce the set of values for polymorphic genetic markers from the analysis. Encoding module 920 encodes the set of values for polymorphic genetic markers into an identifier for the biological sample.

### Identifier Verification

An identifier that is an encoding of a set of values for polymorphic genetic markers can be associated with a biological sample. For example, the identifier can be printed on a label of a plate containing biological sample. In various embodiments, the identifier can be used to verify that the label and the biological sample match genetically.

In various embodiments, the identifier can also be used to verify a relationship with another biological sample. For example, an identifier associated with a first biological sample of a first organism can be used to verify that the first organism and a second biological sample of a second organism match genetically.

### Identifier Verification System

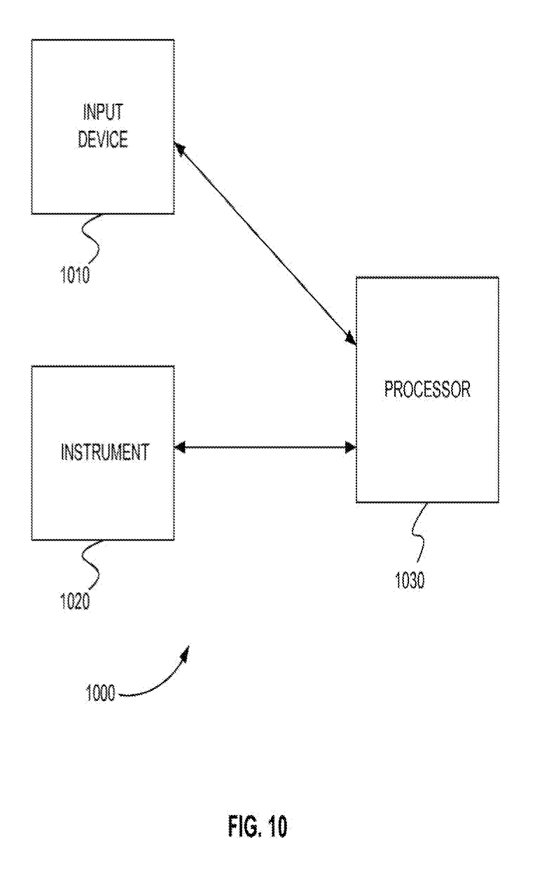

FIG. 10 is a schematic diagram showing a system 1000 for verifying a relationship between a biological sample and an identifier, in accordance with various embodiments. System 1000 includes input device 1010, instrument 1020, and processor 1030. Input device 1010 reads an identifier from a tangible readable medium. Input device 1010 can include, but is not limited to, a barcode scanner, an imaging device, or any input device of a computer or processor.

Instrument 1020 analyzes a nucleic acid of a biological sample. Instrument 1020 produces a set of values for polymorphic genetic markers that identifies the genome content of the biological sample.

Processor 1030 is in communication with input device 1010 and instrument 1020. Processor 1030 compares the identifier with an encoding of the set of values. Processor 1030 verifies a relationship between the biological sample and the identifier if the identifier and the encoding genetically match.

In various embodiments, processor 1030 verifies the type of cell of a cell line. The biological sample is from a cell line, the identifier identifies a cell type, and the relationship verified is that the cell line is of the cell type.

In various embodiments, processor 1030 verifies the plant species of a plant. The biological sample is from a plant, the identifier identifies a plant species, the relationship verified is that the plant is of the plant species.

In various embodiments, processor 1030 verifies the identity of an organism. The biological sample is from an organism, the identifier identifies the organism within a population, and the relationship verified is that the identifier identifies the organism within the population.

In various embodiments, processor 1030 verifies a mother/child relationship between two organisms. The biological sample is from a first organism, the identifier identifies a second organism, and the relationship verified is that the first organism and the second organism have a mother/child relationship.

In various embodiments, processor 1030 verifies a paternity relationship between two organisms. The biological sample is from a first organism, the identifier identifies a second organism, and the relationship verified is that the first organism and the second organism have a paternity relationship.

In various embodiments, processor 1030 compares the identifier with an encoding of the set of values by decrypting the identifier using a decryption algorithm and comparing the decrypted identifier to the set of values.

In various embodiments, system 1000 further includes a biometric reader (not shown). The biometric reader reads a biometric parameter associated with the biological sample. Processor 1030 then compares the identifier with the biometric parameter in addition to the set of values and verifies the relationship between biological sample and the identifier by also determining if the identifier and the biometric parameter biometrically match.

### Identifier Verification Method

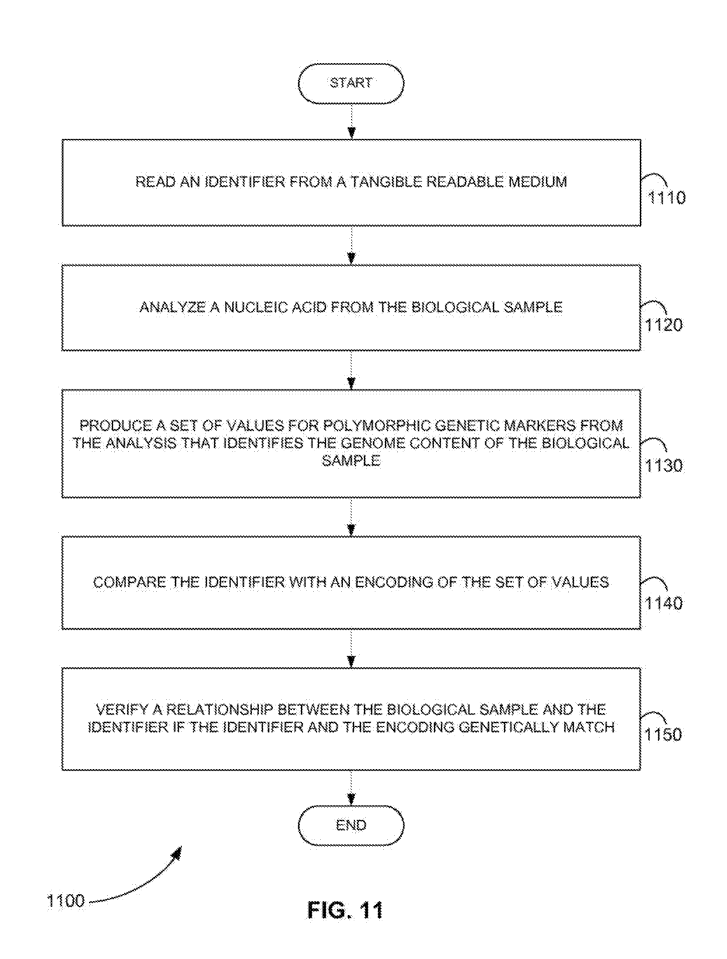

FIG. 11 is a flowchart showing a method 1100 for verifying a relationship between a biological sample and an identifier, in accordance with various embodiments.

In step 1110 of method 1100, an identifier is read from a tangible readable medium.

In step 1120, a nucleic acid from the biological sample is analyzed.

In step 1130, a set of values for polymorphic genetic markers is produced from the analysis that identifies the genome content of the biological sample.

In step 1140, the identifier is compared with an encoding of the set of values.

In step 1150, a relationship between the biological sample and the identifier is verified if the identifier and the encoding genetically match.

### Identifier Verification Computer Program Product

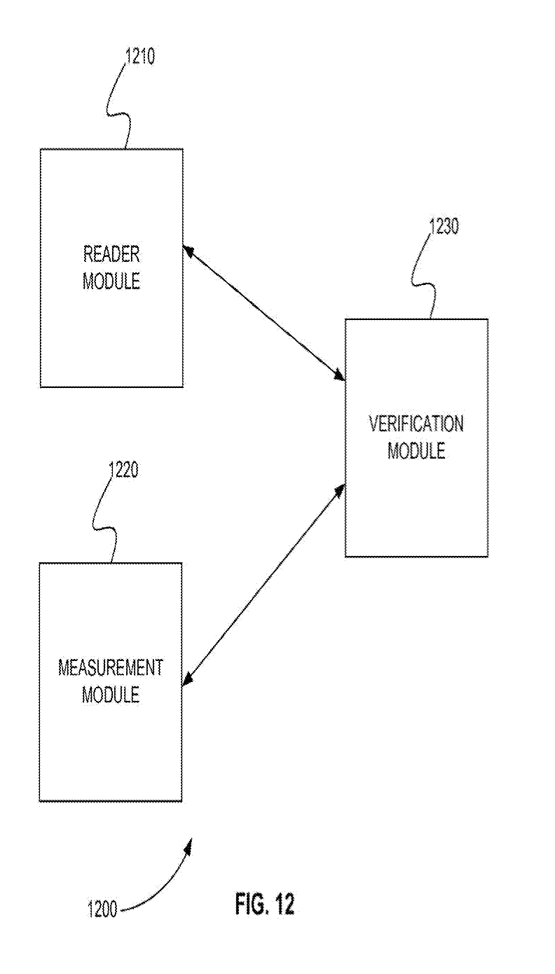

FIG. 12 is a schematic diagram of a system 1200 that includes one or more distinct software modules that performs a method for verifying a relationship between a biological sample and an identifier, in accordance with various embodiments. System 1200 includes reader module 1210, a measurement module 1220, and verification module 1230.

Reader module 1210 receives an identifier from a tangible readable medium read by an input device. Measurement module 1220 receives a set of values for polymorphic genetic markers that identifies the genome content of a biological sample from a instrument. The instrument is used to analyze a nucleic acid of the biological sample and produce the set of values for polymorphic genetic markers from the analysis. Verification module 1230 compares the identifier with an encoding of the set of values. Verification module 1230 verifies a relationship between the biological sample and the identifier if the identifier and the encoding genetically match.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences can be varied and still remain within the spirit and scope of the various embodiments.

Further, a particular sequence of steps or a method or process presented in the specification should not be limited to a single iteration. As one of ordinary skill in the art would appreciate, a particular sequence of steps can be executed or performed in two or more iterations in addition to a single iteration.

1. A system comprising:
a first instrument that analyzes a nucleic acid sample and produces a first set of data from a first set of polymorphic genetic markers for a nucleic acid sample;
a second instrument that analyzes the nucleic acid sample and produces a second set of data from a second set of polymorphic genetic markers for the nucleic acid sample, wherein the polymorphic genetic markers comprise short tandem repeats (STRs), indels and single nucleotide polymorphisms (SNPs);
a database that provides linkage information between the first set of polymorphic genetic markers and the second set of polymorphic genetic markers;
a processor in communication with the first instrument, the second instrument, and the database that receives the first set of data from the first instrument, the second set of data from the second instrument, and the linkage information from the database and that selects a usable value for a polymorphic genetic marker from the second set of data;
searches the linkage information of the database for the polymorphic genetic marker;
determines that the polymorphic genetic marker is not linked to any of the polymorphic genetic markers in the first set of data that have usable values; and
calculates a predictive index of identity based on the usable values in the first set of data and the usable value for the polymorphic genetic marker from the second set of data, wherein the usable value for the polymorphic genetic marker from the second set of data replaces an unusable value in the first set of data in the calculation of the predictive index of identity and wherein the first set of polymorphic genetic markers and the second set of polymorphic genetic markers are different types of polymorphic genetic markers.

2. A method comprising:
receiving a first set of data from a first set of polymorphic genetic markers for a nucleic acid sample from a first instrument that analyzes the nucleic acid sample;
receiving a second set of data from a second set of polymorphic genetic markers for the nucleic acid sample from a second instrument that analyzes the nucleic acid sample, wherein the types of polymorphic genetic markers comprise short tandem repeats (STRs), indels, or single nucleotide polymorphisms (SNPs);
selecting a usable value for a polymorphic genetic marker from the second set of data, wherein the first set of polymorphic genetic markers and the second set of polymorphic genetic markers are different types of polymorphic genetic markers;
searching a database that provides linkage information between the first set of polymorphic genetic markers and the second set of polymorphic genetic markers for the polymorphic genetic marker;
determining that the polymorphic genetic marker is not linked to any of the polymorphic genetic markers in the first set of data that have usable values; and
calculating a predictive index of identity based on the usable values in the first set of data and the usable value for the polymorphic genetic marker from the second set of data, wherein the usable value for the polymorphic genetic marker from the second set of data replaces an unusable value in the first set of data in the calculation of the predictive index of identity.

3. The method of claim 2, wherein the first instrument and the second instrument are the same instrument.

4. A system for generating an identifier for a biological sample, comprising:
a instrument that analyzes a nucleic acid from a biological sample and produces a set of values for polymorphic genetic markers that identifies the genome content of the biological sample, wherein the polymorphic genetic markers comprise a short tandem repeat (STR), an indel, a single nucleotide polymorphism (SNP); and
a processor in communication with the instrument that receives the set of values from the instrument and that encodes the set of values into an identifier for the biological sample, wherein the processor further encodes the set of values into the identifier using an encryption algorithm.

5. The system of claim 4, wherein the biological sample is from a cell line and the identifier identifies the cell type of the cell line.

6. The system of claim 4, wherein the biological sample is from an organism and the identifier identifies the organism enough to determine a mother/child relationship with another organism, a paternity relationship with another organism, or an identity of the organism within a population.

7. The system of claim 4, further comprising a biometric reader that reads a biometric parameter associated with the biological sample, wherein the processor encodes the biometric parameter in addition to the set of values into the identifier for the biological sample.

8-11. (canceled)
